(19) United States
(12) Patent Application Publication
(10) Pub. No.: US 2011/0168612 A1
(43) Pub. Date: Jul. 14, 2011

(54) Storm water filter basket with floating bypass panels

(76) Inventor: Thomas H. Happel, Cocoa, FL (US)

(21) Appl. No.: 13/065,392

(22) Filed: Mar. 22, 2011

Related U.S. Application Data
(63) Continuation-in-part of application No. 12/800,706, filed on May 21, 2010.
Application No. 12/800,706 is a continuation-in-part of application No. 12/592,805, filed on Dec. 4, 2009.
Application No. 12/592,805 is a continuation-in-part of application No. 12/587,574, filed on Oct. 13, 2009.
Application No. 12/587,574 is a continuation-in-part of application No. 12/387,583, filed on May 6, 2009.
Application No. 12/387,583 is a continuation-in-part of application No. 12/315,820, filed on Dec. 8, 2008, now Pat. No. 7,846,327.
(60) Provisional application No. 61/009,086, filed on Dec. 27, 2007.

(51) Int. Cl. B01D 35/02; C02F 1/00; E03F 5/14

(52) U.S. Cl. 210/122

(57) ABSTRACT

The present invention is a nutrient separating baffle box having a screened filter basket therein for a storm water drain system and especially to a screened filter basket having floating bypass panels to allow the capture of floating debris in the filter basket and when the basket cannot pass enough water flow therethrough to thereby allow bypass of storm water while retaining floating debris in the filter basket.

### BACKGROUND OF THE INVENTION

This patent application is a continuation-in-part application of my pending U.S. patent application Ser. No. 12/800,706, filed May 21, 2010, for Filter Skimmer & Filter Apparatus which is a continuation-in-part application of my pending U.S. patent applications Ser. No. 12/592,805, filed Dec. 4, 2009 for Floating Baffle Panel and Filter Apparatus; which is a continuation-in-part of my pending U.S. patent application Ser. No. 12/587,574 filed Oct. 13, 2009, for Floating Skimmer Apparatus with Up-flow Filter; which is continuation-in-part of my pending U.S. patent application Ser. No. 12/387,583, filed May 6, 2009 for a Storm Water Filter System Having a Floating Skimmer Apparatus; which is a continuation-in-part of my pending U.S. patent application Ser. No. 12/315,820, filed Dec. 8, 2008 for a Storm Water Filter System Having a Floating Skimmer Apparatus; which is based on my U.S. Provisional patent application Ser. No. 61/009,086, filed Dec. 27, 2007 for a Floating Skimmer Apparatus.

The present invention is for a nutrient separating baffle box having a nutrient separating filter basket therein for a storm water drain system and especially to. a nutrient separating filter basket having floating bypass panels to prevent overflow of storm water and floating debris when the basket cannot pass enough storm water through the basket screens.

A filter basket is installed within a storm water drain pipe system and receives storm water runoff therethrough and collects organic materials, such as grass clippings, leaves and tree stems, therein.

Drain water, which is frequently laden with trash, grass clippings, tree leaves and stems, sand, gravel, and other forms of sediment, is collected from streets, parking lots and other areas into a storm drain inlet where it is directed into a storm water drain pipe system. The drain water laden with trash, leaves, grass clippings, sand and gravel collected from the streets is fed through an entrance into a storm water catch basin and into a lake or retention pond. The retention pond can tolerate a certain amount of grass clippings and leaves collected from parking lots or along the street but debris left in the water for a long period of time decays and allows a buildup of soluble nutrients, such as nitrates and phosphates, to accumulate in the water. Thus, it is desirable to remove organic debris from the water collected from the drain water before it enters into lakes and retention ponds.

The objective of the Nutrient Separating Baffle Box is to treat a storm drain pipe by capturing solids such as foliage, litter, and sediments, and lighter than water liquids such as petroleum products. During a rain event, as water flows into the Nutrient Separating Baffle Box floatables such as foliage and litter are captured in the screen system, and sediments which are heavier than water, settle and pass through the screen system settling in the lower baffled settling chambers. After the rain event is over the hydraulic grade line of the water in the Nutrient Separating Baffle Box lowers to a level that is even with the tops of the baffles which is below the bottom of the screen system. This allows for the captured debris in the screen system to dry out between rain events, and not allow the nutrients in the captures foliage to leach into the water and become food for bacterial growth.

This process of treating the water flow can create headloss which could impede the flow and reduce the rate of treatment. If the treatment results in a significant reduction in the rate of flow it is possible for flooding to occur upstream from the storm water treatment structure. The Nutrient Separating Baffle Box provides treatment with minimal headloss by providing a conveyance for water flow through the vault that is equal or greater than the cross-sectional area of the inflow pipe below the ceiling of the inflow pipe. A screen system in the Nutrient Separating Baffle Box that does not employ the floating bypass panel system accomplishes this by having a low section in the screen system on both the left and right sides adjacent to the inflow pipe: These low sections are referred to as by-pass sections and are typically significantly lower than the main body of the screen system and are also lower than the ceiling of the inflow pipe. The width of the screen system is such that the outside of the screen system is a distance from side wall of the vault on both the left and right side of the screen system. The combined space between the screen system and the side walls of the vault is such that the cross-sectional area exceeds that of the inflow pipe. In the event that the screen system becomes obstructed with debris and cannot pass enough flow to meet that of the inflow pipe, the water can by-pass the screen system by flowing out of the screen system over top of the by-pass screen sections adjacent to the left and right of the inflow. After the water flow is outside the screen system it is conveyed down the length of the vault between the screen system and the side wall of the vault.

When water is flowing over top of the by-pass sections in the screen system a deficiency occurs because floatables now have the potential to escape the screen system. The advantage of the floating bypass panel system is that it will provide adequate flow by-pass below the ceiling of the inflow pipe without the potential for being topped by water flow and prevent floatables from escaping the screen system. The floating bypass panel system is a floating skimmer section incorporated into both the left and right side of the screen system adjacent to the inflow. During rain events that require water flow to by-pass the screen system, rather than have water flow over the top of a low section in the screen system for by-pass, the floating skimmer panels of the floating bypass panel system move up with the rising water level to create an opening below the skimmer panel which is adequately below the water level to prevent floatables from escaping the screen system.

Prior art U.S. Patents which show filter baskets for storm water drain systems can be seen in the following patents. In the Happel et al, U.S. Pat. No. 7,270,747 a storm water drain system has a nutrient separating filter basket for collecting organic materials such as grass clipping and the like from storm water runoff. The filter basket has a plurality of doors to allow the in situ cleaning of debris therefrom. In U.S. Pat. No. 7,153,417 to Happel, a floating storm water drain filter system has a floating debris capturing basket for collecting debris from entering storm water. The floating basket is thereby able to maintain its position relative to incoming storm water in an in-line storm sewer drain. In Happel et al U.S. Pat. No. 7,294,256, a storm water filter system for filtering storm water being fed into an in-ground well includes a inlet filter basket. In Happel U.S. Pat. No. 6,797,162, a catch basin filter for storm water runoff is mounted to a curb and includes a ramp feeding runoff water over a weir into a filter basket. In the Happel U.S. Pat. No. 6,428,692 for an In-Line Storm Water Drain Filter System an in-line storm water drain filter and baffle box is installed within a storm water drain pipe to direct storm water runoff through the storm water drain pipe and through the filter and baffle box prior to the storm water drain water passing through an outfall into a lake, pond or retention area. This patent is for a filter system and includes a housing having an inlet and outlet and a plurality of chambers formed therein. The housing cover allows for access into a housing. A plurality of filter screens are mounted over each of the plurality of ,housing chambers for collecting trash from the storm water passing therethrough. The Happel U.S. Pat. No. 6,869,525 a Storm Drain Filter System is shown having a storm drain filter system which includes a skimmer for collecting floating hydrocarbons and for absorbing the hydrocarbons in a hydrocarbon absorbing boom while preventing them from passing out of the skimmer.

Other U.S. Patents include the Nicholas U.S. Pat. No. 6,379,541 for a storm water sediment and litter trap which includes an upwardly inclined flume feeding a screened collection chamber. The screened filter trap is mounted in adjacent the discharge end of a storm water outlet. In the Turner, Jr. et al., U.S. Pat. No. 5,562,819, an apparatus for trapping, signaling the presence of and collecting debris in waterways has an in-line trap in a subterranean chamber which has a net enclosing the inlet to a storm water drain conduit.

The present invention is a nutrient separating baffle box having a nutrient separating filter basket therein for a storm water drain system and especially to a nutrient separating filter basket having floating bypass panels to allow overflow from the filter basket when the basket cannot pass enough water flow therethrough to thereby prevent overflow of storm water and floating debris.

### SUMMARY OF THE INVENTION

The present invention is a storm water nutrient separating box having a nutrient separating filter basket installed therein within a storm water drain pipe system to receive storm water runoff therethrough and collect organic materials, such as grass clippings, leaves, and tree stems. The storm water nutrient separating box has a housing defining a chamber therein and an inlet thereinto and an outlet therefrom. An inlet nutrient separating filter basket has a plurality of screened sides and a top and bottom and an open front end with the open front end being positioned in front of the housing inlet. The inlet filter basket has an opening in the screened sides thereof. A floatable panel is slidably mounted in the opening in the screened side and has a floatable panel having a rest position blocking the flow of storm water through the opening in the screened panel and which panel is floatable with rising water in the filter basket to raise the floatable panel and open an area thereunder to the flow of storm water thereunder. The storm water nutrient separating box filter basket filters materials from storm water entering thereinto while preventing overflow of storm water and floating debris from the filter basket. The basket may have a plurality of openings each having a floating panel mounted therein and each having a flotation member attached thereto. The panel may also have load and centering rollers on each edge thereof to assist in the sliding of the panels in a track on either side of each opening in the screened side of the filtering basket.

### BRIEF DESCRIPTION OF THE DRAWINGS

Other objects, features, and advantages of the present invention will be apparent from the written description and the drawings in which:

FIG. 1 is a side sectional view of a filter basket mounted in the storm drain system with no water flow;

FIG. 2 is a side sectional of the filter basket of FIG. 1 in a storm drain system with water flowing therethrough;

FIG. 3 is a side sectional of the filter basket of FIGS. 1 and 2 with high water level and elevated floating panel;

FIG. 4 is a partial perspective view of the filter basket floating panel at rest in a non-floating position.

FIG. 5 is a partial perspective view of the filter basket floating panel in a raised floating position.

FIG. 6 is a perspective view of the floating panel having the having the load and centering roller thereon;

FIG. 7 is a top plan view of the filter basket with unobstructed water flow; and

FIG. 8 is a top plan view of the filter basket showing water flow with floating panels elevated.

### DESCRIPTION OF AN EXEMPLARY EXAMPLE

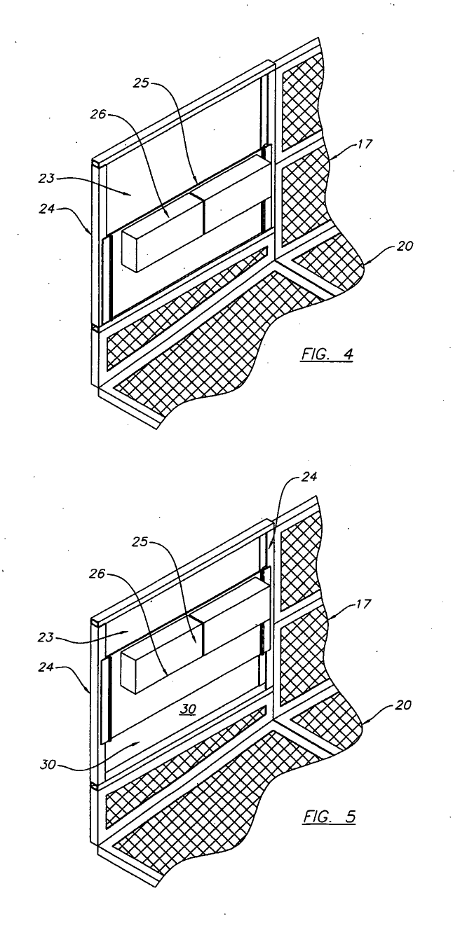

Referring to the drawings and especially to FIGS. 1 through 3, a storm water nutrient separating box 10 has a chamber 11 therein and has an inlet 12 and an outlet 13 therefrom. The box 10 may have openings 14 thereinto and baffles 15 extending from the bottom of the box 10. A nutrient separating filter basket 16 has screened sides 17, a screened bottom 20 (FIGS. 4 & 5) and may optionally have a screen top.

The screened basket 16 is supported on posts 21 attached to the baffles 15 and has an open front 22 facing the inlet 12 for capturing storm water entering the box 10 through the inlet 12. As seen in FIGS. 1 through 5, the screened basket 16 has an opening 23 in each side of the basket. The opening has a track 24 on each side thereof and has a floatable panel 25 slidably supported in the tracks 24. The panel 25 has a pair of floatation members 26 mounted thereto along the top edge 27 thereof facing the inside of the basket 16.

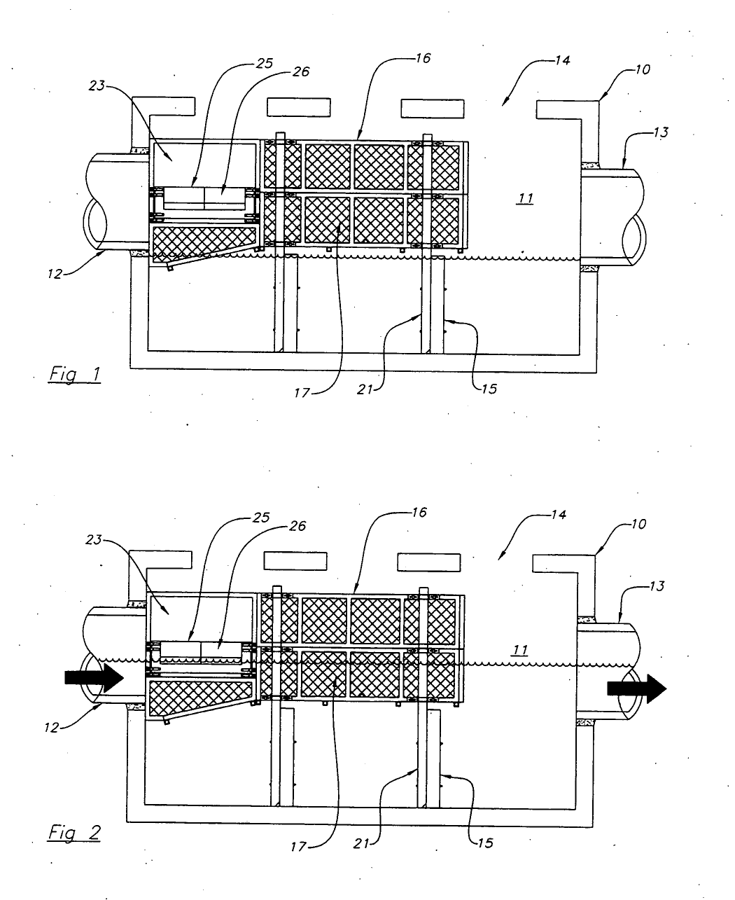

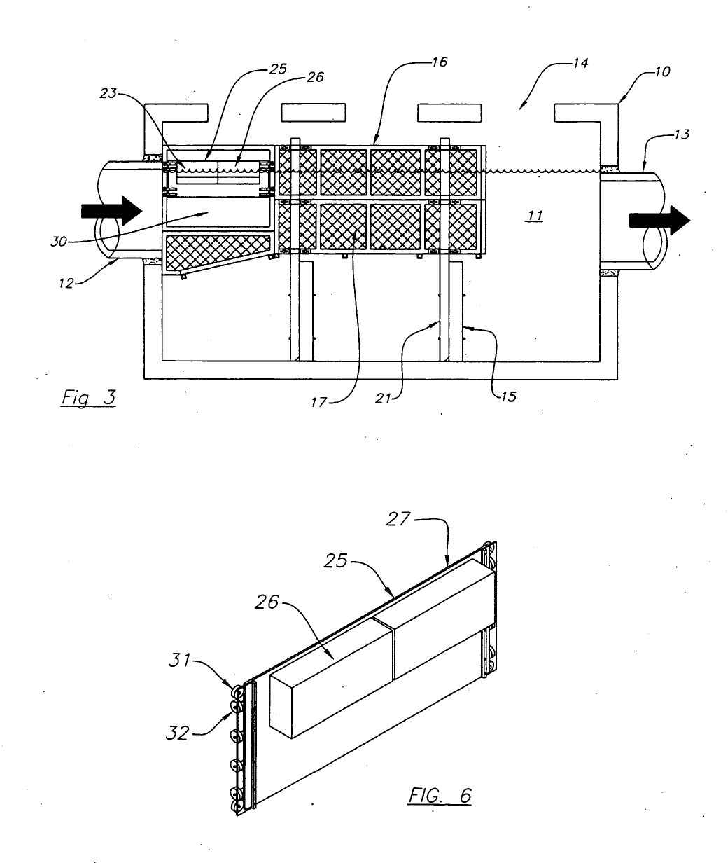

FIG. 1 is a sectional view of the nutrient separating box 10 having no water flowing into the box and the floatable panel 25 in a rest position. FIG 2 is the same view of the box 10 having a normal water flow with the floating panel still at rest on the bottom of the track frame and all water passing through the nutrient separating screen basket into the box chamber 11. Floatable debris is guided into the screen basket 16. FIG. 3 is the same view as FIGS. 1 and 2 with water flowing at a high hydraulic grade line. The floating panel 25 is acting as a skimmer and directing floatable debris into the screened basket 16. The floating panel 25 has opened an area 30 therebelow for the overflow of storm water to pass while preventing floatable debris from flowing thereover.

FIG. 4 shows the floatable panel 25 in a rest position resting on the bottom track frame. Water passes through the screens with the floating panel 25 acting as a skimmer directing floatables into the body of the screen basket 16. FIG. 5 is the same view as FIG. 4 but the floating panel is in a raised position. Water passes through the screens in the basket and under the floating panel 25. The floating panel 25 acts as a skimmer directing floatable debris into the body of the screen basket 16 while allowing water to pass underneath. Because the float members 26 are on the inside of the screen basket 16, the position of the floating panel 25 is based on the water level on the inside of the screen basket 16.

FIG. 6 more clearly illustrates the floatable panel 25 having the float members 26 adjacent the top edge 27. the panel 25 has a plurality of rollers on either side thereof including a plurality of centering rollers 31 and load rollers 32. The load rollers 32 handle force of water flow and reduce friction. The centering rollers 31 prevent friction from side to side.

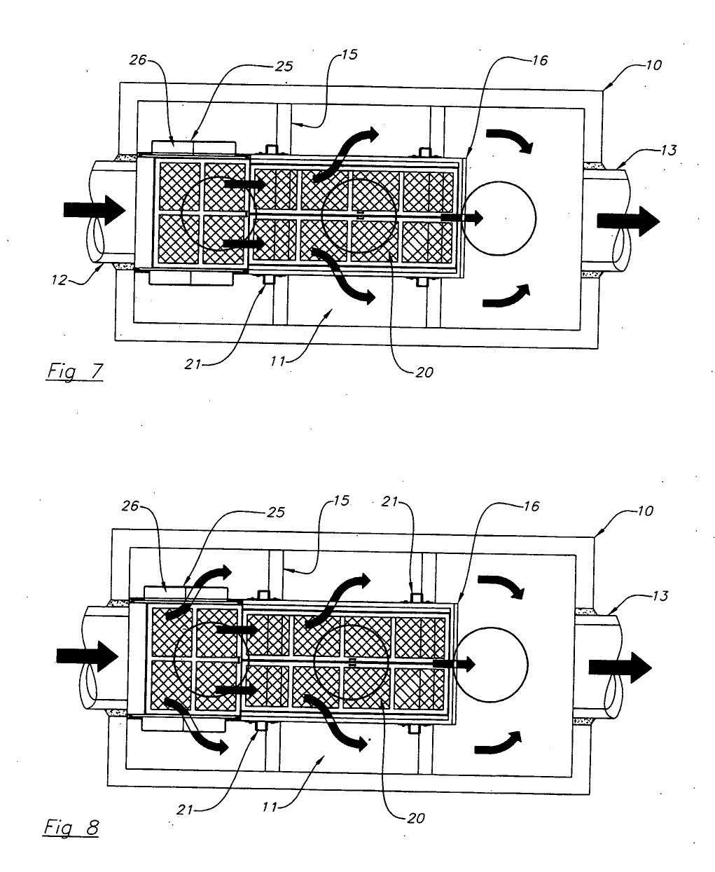

FIGS. 7 and 8 illustrates the flow of storm water through the nutrient separating box 10 from the inlet 12 to the outlet 13. In FIG. 4 the floating panel 25 with floats 26 is at rest and all the water is flowing through the screens of the screened basket 16. In FIG. 8 the floating panels are in a floating or raised position and the water flows through the screens of the screened basket 16 and under the panels 25 and into the chamber 11 and out the outlet 13.

As seen in all the drawings, the floating bypass panel system is incorporated into the framework of the screen system in the. Nutrient Separating Baffle Box. The floating bypass panel system has a frame with vertical channels acting as a track system and will guide the floating skimmer panels 25 up and down as needed during rain events. To reduce friction from preventing the floating skimmer panels 25 from moving as required, marine grade rollers 31 and 32 are attached to each corner of the skimmer panel by brackets and allow movement with minimal friction.

The floatation of the floating skimmer panels 25 of the floating bypass panel system will be derived from a float 26 attached to the face of the skimmer panel 25 on the inside of the screen system. The float is spaced off the skimmer panel so that the water on the inside of the screen system can encapsulate the float. This results in the buoyancy and the vertical positioning of the floating skimmer panel 25 to be determined by the water level on the inside of the screen basket 16.

When there is no water flowing through the storm drain pipe the static water level in the Nutrient Separating Baffle Box 10 is below the screen basket 16 and the floating skimmer panels 25 which are at rest on the bottom of a track system. After a rain event begins and water is flowing through the inlet 12 the hydraulic grade line in the. Nutrient Separating Baffle Box 10 begins to rise. The floating skimmer panels 25 of the floating bypass panel system will not rise up with the changing water elevation until after the water level reaches a specific predetermined water elevation. For most rain events the floating skimmer panels of the floating bypass panel system may not ever move. As the hydraulic grade line continues to rise, eventually the floating skimmer panels 25 will begin to float and move up with the water level. As the skimmer panels 25 move up, an opening under the panel is created and enlarges which allows water to flow out and around the screen basket 16. When the water flow is by-passing the screen system by flowing under the floating skimmer panels 25, floatables that enter the Nutrient Separating Baffle Box 10 continue to be directed into the body of the screen basket 16 and are not allowed to escape. When the water flow begins to decrease in volume the hydraulic grade line lowers in elevation, the floating skimmer panels 25 of the floating bypass panel system lower with the changing water level and eventually come to rest on the bottom of the tracks. Eventually, the rain event will end and the water level within the Nutrient Separating Baffle Box 10 will lower to an elevation that is even with the tops of the baffles 15 and the captured debris in the screen system will begin to dry out.

A significant feature of the floating bypass panel system is that because an opening in the screen system is created at an elevation close to the bottom of the inlet and outlet, headloss of the screen system is minimized during large flow events. The openings under the floating bypass panels 25 can be sized to exceed that of the inlet 12. In the event that the screen system becomes completely clogged with debris, a significant conveyance is made through the screen system which will allow the water to continue to adequately flow to prevent flooding upstream without the loss of previously captured floating debris.

It should be clear at this time that a storm drain filter basket has been provided which advantageously has a nutrient separating filter basket having floating bypass panels to allow overflow when the basket cannot pass enough water flow therethrough. However, the present invention is not to be construed as limited to the forms shown which are to be considered illustrative rather than restrictive.

I claim:

1. A storm water filtration system comprising:
a housing defining a chamber therein and having an inlet thereinto and an outlet therefrom;
an inlet filter basket having a plurality of screened sides and bottom and having an open front end, said open front end being positioned in front of said housing inlet, and said inlet filter basket having an opening in one of said plurality of screened sides; and
a floatable panel slidably mounted in said opening in one of said plurality of screened sides, said floatable panel having a rest position blocking the flow of storm water through said opening in said screened panel and being floatable with rising water in said filter basket to raise said floatable panel and open an area thereunder to the flow of storm water thereunder;
whereby a storm water filtration system filters materials from storm water entering thereinto and prevents floating debris from escaping by overflowing said filter basket.

2. A storm water filtration system in accordance with claim 1 in which said inlet filter basket plurality of screened sides has a plurality of openings therein each having a floatable panel slidably mounted therein.

3. A storm water filtration system in accordance with claim 1 in which said inlet filter basket has an opening in two sides of said plurality of screened sides, each opening having a floatable panel slidably mounted therein.

4. A storm water filtration system in accordance with claim 1 in which said inlet filter basket opening has two sides each side having a track thereon having said floatable panel slidably mounted therein.

5. A storm water filtration system in accordance with claim. 4 in which said floatable panel has two sides each side having a plurality of rollers mounted thereon for sliding in said side tracks.

6. A storm water filtration system in accordance with claim 1 in which said floatable panel has a top and a bottom and an inside surface facing into said filter basket, said floatable panel having a flotation member attached thereto adjacent the top thereof on the inside surface thereof.

7. A storm water filtration system in accordance with claim 5 in which said floatable panel has a plurality of centering rollers on each side thereof.

8. A storm water filtration system in accordance with claim 7 in which said floatable panel has a plurality of load rollers on each side therof.

9. A storm water filtration system in accordance with claim 6 in which said floatable panel has two flotation members attached thereto.

10. A filter basket for a storm water filtration system comprising:
a filter basket screen system having a plurality of screened sides and bottom and having an open front end for receiving storm water thereinto, said inlet filter basket having an opening in one of said plurality of screened sides; and
a floatable panel slidably mounted in said opening in one of said plurality of screened sides, said floatable panel having a rest position blocking the flow of storm water through said opening in said screened panel and being floatable with rising water in said filter basket to raise said floatable panel and open an area thereunder to the flow of storm water thereunder;
whereby a storm water filter basket filters materials from storm water entering thereinto while preventing floating debris from escaping from said filter basket.

11. The filter basket for a storm water filtration system in accordance with claim 10 in which said inlet filter basket plurality of screened sides has a plurality of openings therein each having a floatable panel slidably mounted therein.

12. The screened filter basket for a storm water filtration system in accordance with claim 10 in which said inlet filter basket has an opening in two sides of said plurality of screened sides, each opening having a floatable panel slidably mounted therein.

13. The screened filter basket for a storm water filtration system in accordance with claim 10 in which said inlet filter basket opening has two sides each side having a track thereon having said floatable panel slidably mounted therein.

14. The screened filter basket for a storm water filtration system in accordance with claim 13 in which said floatable panel has two sides each side having a plurality of rollers mounted thereon for sliding in said side tracks.

15. The screened filter basket for a storm water filtration system in accordance with claim 10 in which said floatable panel has a top and a bottom and an inside surface facing into said filter basket, said floatable panel having a flotation member attached thereto adjacent the top thereof on the inside surface thereof.

16. The screened filter basket for a storm water filtration system in accordance with claim 14 in which said floatable panel has a plurality of centering rollers on each side thereof.

17. The screened filter basket for a storm water filtration system in accordance with claim 16 in which said floatable panel has a plurality of load rollers on each side therof.

18. The screened filter basket for a storm water filtration system in accordance with claim 15 in which said floatable panel has two flotation members attached thereto.
